(19) United States
(12) Patent Application Publication
(10) Pub. No.: US 2003/0126456 A1
(43) Pub. Date: Jul. 3, 2003

(54) Method for licensing software

(75) Inventors: Johannes Birzer, Stulln (DE); Mirko Danz, Feucht (DE); Andreas Hartinger, Erlangen (DE); Martin Kiesel, Poxdorf (DE)

Correspondence Address: Henry M. Feiereisen, Suite 3220, 350 Fifth Avenue, New York, NY, 10118, US

(73) Assignee: Siemens Aktiengesellschaft, Munchen (DE)

(21) Appl. No.: 10/292,889

(22) Filed: Nov. 12, 2002

(30) Foreign Application Priority Data
Nov. 14, 2001 (DE) 101 55 752.3

(51) Int. Cl. H04L 9/32

(52) U.S. Cl. 713/193

(57) ABSTRACT

A method is disclosed for licensing software components and providing access authorization to software components and/or instantiations of software objects through licenses, wherein a license is associated with each software module and/or the instantiation of a module. Licensing is based on a comparison between acquired licenses and the licenses required for an application. A comparison is performed by a license manager which in distributed environments is advantageously implemented as a mobile agent.

### CROSS-REFERENCES TO RELATED APPLICATIONS

This application claims the priority of German Patent Application, Serial No. 101 55 752.3, filed Nov. 14, 2001, pursuant to 35 U.S.C. 119(a)-(d), the disclosure of which is incorporated herein by reference.

### BACKGROUND OF THE INVENTION

The present invention relates to a method for licensing and/or access authorization of software modules for industrial controllers, control systems and/or computer systems.

It is customary to link licensing and access authorization of software modules explicitly to these software components. For example, if a user uses the software module A three times, the software module B twice, and the software module C once, then he obtains from the software supplier a specific authorization for the corresponding desired and requested requirements in form of licenses. Each individual software module can be provided, for example, with a software protection mechanism implemented by a release code. This has a disadvantage that a separate operation is required for the release of each module. Examples are certain office programs, such as word processing programs for personal computers.

It would therefore be desirable and advantageous to provide an improved licensing method for software modules and/or method for access authorization of software modules, which obviates prior art shortcomings and which is simple in structure and employed with particular ease in distributed systems.

### SUMMARY OF THE INVENTION

According to one aspect of the present invention, a software module subject to a license carries at least one piece of information about its own license requirements. A use of the software module subject to a license is authorized if a license is present, wherein the number of licenses for the software modules subject to a license in an industrial controller and/or industrial control system and/or computer system is monitored at least during certain time intervals and compared to the number of software modules subject to a license. The number of the software modules subject to a license under authorized use is equal to or smaller than the number of the licenses.

The term software module will be used hereinafter synonymously with the term software program or software component. This includes, for example, software for office applications, software for controllers and/or software for computer systems. The term control will be used synonymously with automatic control, open-loop control and the like.

Advantageously, a customer or user can contract, purchase or own licenses for a certain number of individually used software modules, wherein a license manager will analyze the licenses with respect to the number of required licenses and the number of the existing licenses. A user of software modules subject to a license can use the required software modules within the total number of acquired licenses flexibly and as the needed. Each license of the software modules associated with a required license can be differently priced. There is no need to change the license contract when the user changes the configuration of the system of industrial controllers, control systems or computer systems, if the number of the actually required software modules is smaller than or equal to the number of acquired licenses. The license manager significantly facilitates the administration of licenses and software not only for a single system, but also for an entire business. The proposed method can also have advantages for computer networks. By using a license manager for the use of software modules, the customer can change his software requirements more easily and without the need to change the license contract. This saves additional administrative costs and procedures. The customer can therefore obtain an access authorization, i.e., a license for use of a certain quantity of licensed software modules, whereby the user can change the number of the used licenses as long as a number of acquired licenses is greater than or equal to the number of the actually used software modules subject to a license.

According to another advantageous embodiment, the license manager can be used in a distributed system of industrial controllers, control systems and/or computers. This simplifies and makes more cost-effective the administration of licenses in particular in distributed systems.

According to yet another advantageous embodiment, a user can be authorized to use the actually desired software modules, when the number of the software licenses already acquired by the customer reaches at least the sum total of licenses of the actually desired software modules.

A customer can receive accounting statements reflecting the actual requirements and the use, in that a license manager permanently captures the actual number of required licenses and compares that number with the existing licenses. The license manager can easily integrate and take into consideration recently acquired licenses, as well as additionally required licenses for an application. The license manager determines permanent the “License Debit”, i.e., the sum of the licenses for all actually required software modules, and compares those with the “License Credit”, i.e., the number of licenses acquired by a customer or user.

According to yet another advantageous embodiment, the license manager can be implemented as a mobile agent, which allows the licensing method to be easily employed in distributed environments. The software modules subject to a license can then be executed on devices connected, for example, via Fieldbus links, as well as local area networks (LAN) or Internet and intranet links.

Advantageously, the licenses required by a system for an application can be computed automatically. A user can thereby immediately recognize the licensing costs associated with a selected configuration of software modules or applications. The required licenses can be determined by the license manager or, for example in industrial controllers, by a routine in the engineering system.

According to another advantageous embodiment, the licenses can be transmitted via a data link or the Internet to the industrial controller/control system or to at least one computer system. Accordingly, an additional data carrier or an additional hardware component is not required for transmitting the license to the customer.

According to yet another advantageous embodiment, the licenses can be supplied on a data carrier which is already implemented for operating the controller or computer system. This facilitates handling of the controller and/or computer system and can also save both storage space and storage costs.

Advantageously, the licenses can be supplied to the controller or computer system on a memory card. A memory card which can be inserted easily into a provided slot is typically routinely used with control devices.

According to another advantageous embodiment, the licenses can be supplied to the control or computer system on a Multi-Media-Card (MMC) memory card which are suitable as information carriers due to their small size. MMC memory cards have a similar appearance as the small SIM card used in cell phones.

Advantageously, licenses for the entire system and/or an entire installation can be supplied at a single point and/or a single device or at different points and/or at different devices. This allows a customer to import license information in the same manner for software components relating to the entire system or installation at a single point, for example a single device. This simplifies license handling by a customer, in particular in distributed applications and network operation.

Advantageously, a comparison required for the access authorization between the required licenses and the obtained licenses can be made when the software modules are installed. In other words, it is checked only at the time when a customer or user of the software modules installs the acquired software modules on a device or a system, if the obtained licenses are sufficient for the desired software modules. Moreover, by debiting a customer account for the license only when the software module is installed on a device or a system, it is only checked if the customer is authorized to use the software modules at a time when the customer actually intends to use the modules. The licenses are therefore entered into the accounting system only when actually required. For example, although many functions of software can be anticipated, a license need only be obtained when these functions are actually used.

Advantageously, a comparison required for the access authorization between the required licenses and the obtained licenses can be made when the software modules are actually used. The licenses can hence be coupled to the number of manifestations and/or instantiations of the software modules. In this way, application-specific licenses can be provided to a customer for his specific requirements. A customer who acquires a software module, for example a technology packet “positioning”, for motion control in an industrial controller, does not pay for the software when he installs the technology packet, but rather only pays when a technology object of this technology packet “positioning” is actually used. The technology packet “positioning” can also include the technology object “positioning axis”. A customer is billed for the required number of manifestations and/or instances of the technology object “positioning axis” or additional technology objects, i.e., his license account is debited for the number of the manifestations and/or instances of the technology objects. By authorizing specific instances at run-time, the license account of a customer is only debited for those software modules which are actually needed and used for the applications. This provides for a finely granulated accounting mechanism, so that a customer has to pay only for the required and actually used functionality. Different technology objects and/or software modules are used, for example, in machine tools with CNC control.

Licenses can be stored on memory cards and/or MMC memory cards by providing these computer-readable data carriers with an unalterable hardware identification and with additional license information in form of an identification number that is generated by a encryption algorithm and uniquely associates the hardware identification with the license information, which are then supplied to a computer system or the control device that execute the software components in form of the computer-readable data carrier.

Advantageously, the unique hardware identification (ID) which is placed on the data carrier by the manufacturer during the manufacturing process of the computer-readable data carrier, is written in a region of the data carrier which is subsequently only readable, but not writable. The hardware ID is only given out once and is therefore unique. Since a region containing the hardware ID can only be read out, but not written to, the hardware ID (for example the serial number) cannot be copied to another data carrier of this type, which makes cloning of data carriers impossible. In addition to the hardware ID, the computer-readable data carrier includes additional useful data regions which may be writable.

The usable data regions of the computer readable data carrier can include, for example, information which can be used for operating a computer system or a control device. To operate controllers, the usable data regions of the computer-readable data carrier can include, for example, the complete run-time software and/or parameterization and/or configuration information, as well as applications.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic diagram of software modules for motion control;

FIG. 2 shows schematically a technology packet with technology objects for positioning;

FIG. 3 depicts a scenario for licensing and access authorization of software modules on a device;

FIG. 4 depicts a scenario for licensing and access authorization of software modules for several networked devices;

FIG. 5 shows schematically the content of a Multi-Media-Card (MMC) memory card; and

FIG. 6 shows a schematic diagram of the connection of control devices with a server via an Ethernet or Internet link.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way.

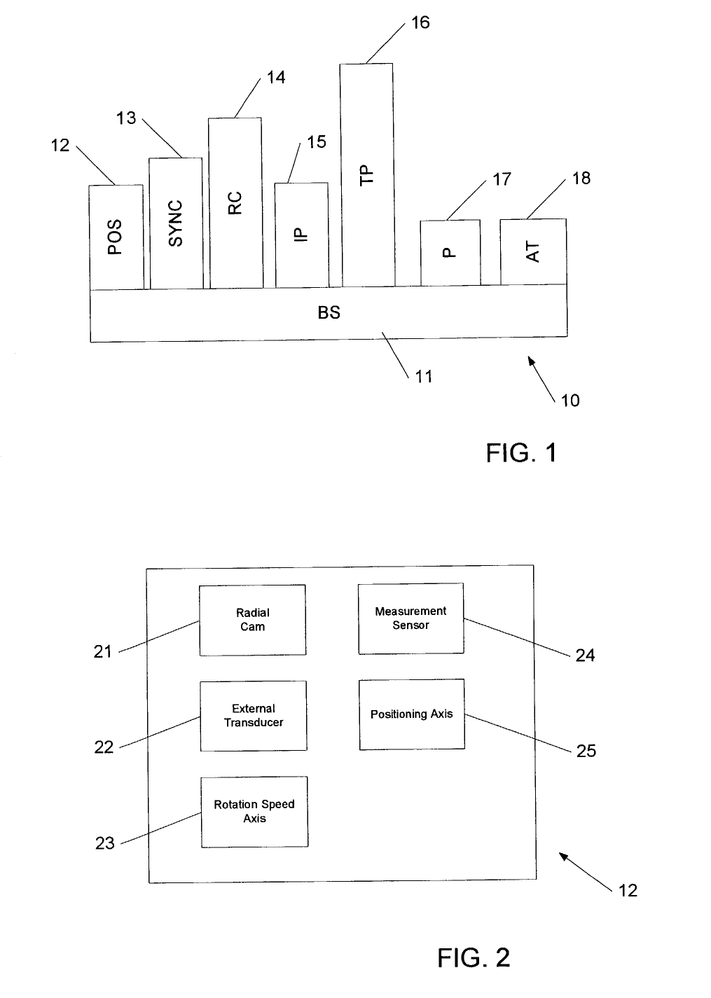

Turning now to the drawing, and in particular to FIG. 1, there are shown exemplary software modules indicated schematically by rectangles for a motion controller 10. A motion controller typically includes a basic system 11 (BS) and software modules 12 (POS; Positioning), 13 (SYNC; Synchronization), 14 (RC; Radial Cam), and 15 (IP; Interpolation), which a user can obtain according to the specific requirements and intended applications. The software modules 11 to 15 represent technology packets for certain functionalities and can include additional technology objects. For example, the software module 12 can be implemented twice or three times, hence requiring two or three licenses (not shown in FIG. 1). In addition to the basic system 11, a user or purchaser can acquire software modules 12 for positioning, 13 for synchronization, 14 for radial cam disks, and/or 15 for interpolation, as well as the corresponding licenses. The user can also purchase a total package that includes Positioning, Synchronization, Radial Cams, and Interpolation in a single software module 16 (TP; Total Packet). As an example, a license can be obtained for the software module 12 POS, another license for the software module 13 SYNC, etc. In addition to the typical functionalities for motion control devices, a user or customer can also acquire software modules 17 (P; Plastic) or 18 (AT; Additional Technologies) for specific technologies. The software component 17 (Plastic) can be acquired for motion control devices that are intended to be used specifically for plastic machining. The specific software components 18 (AT) can be required to handle additional technologies. All the illustrated software modules have associated therewith a license. A user can flexibly use the desired software modules by staying within the number of the acquired licenses. Accordingly, a user can scale the motion control device simply by using certain software modules and thereby customize the control tasks.

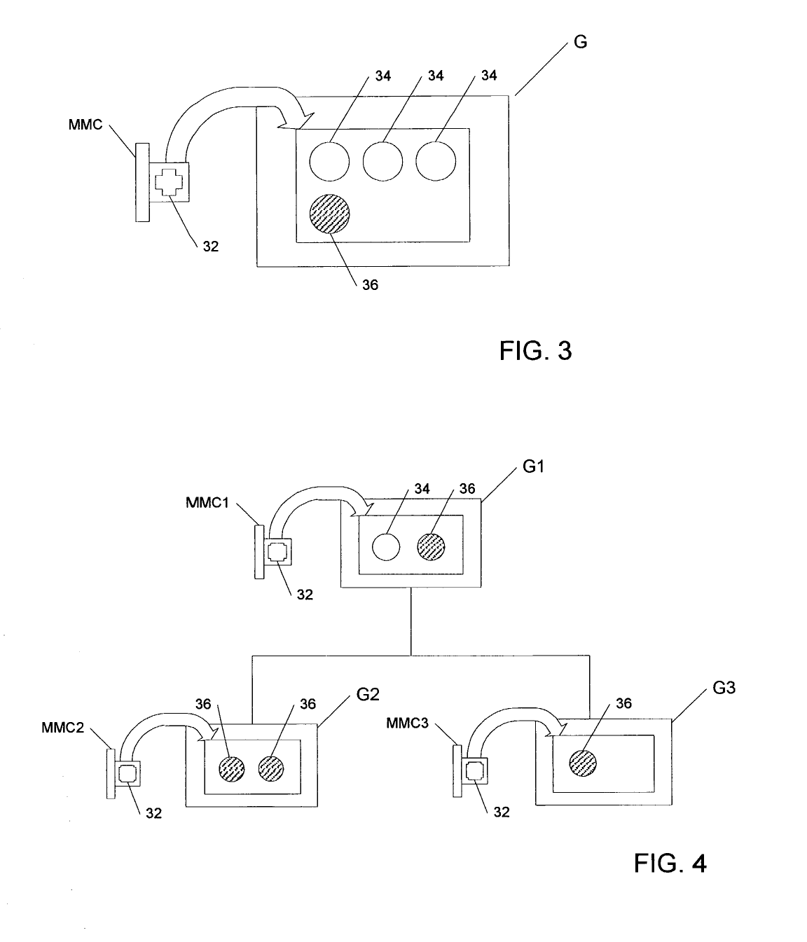

FIG. 2 shows schematically an exemplary technology packet 12 “Positioning”. The technology packet may include the following exemplary technology objects which are indicated as rectangles: 21 (Radial Cam), 22 (External Transducer), 23 (Rotation Speed Axis), 24 (Measurement Sensor) and 25 (Positioning Axis). A user can use several embodiments or instances of these technology objects in a single application.

User authorization (i.e., a check if sufficient licenses are available at the customer/user for the desired software module) can then be checked during installation, i.e., when the technology packet are loaded. Alternatively, the user authorization can be checked during use, i.e., when the technology objects are instantiated. For example, if the use of four technology objects 23 (Rotation Speed Axis) is anticipated, then a user who wishes to use four instances of the technology object 23 (Rotation Speed Axis) has to obtain four licenses. This possibility of linking the licensing process to the actual use of the technology objects is flexible and transparent to the customer.

FIG. 3 depicts a scenario for licensing and access authorization of software modules on a single device using licenses. Software modules subject to licenses, such as instances of technology objects indicated as small circles, are to run on the device G (e.g., a motion controller). The device G is shown as a rectangle. An identification number 32 (PIN), which designates the software licenses, is assigned to the device on an integratable MMC-memory card MMC. Instances 34, 36 to be executed on the device G are indicated by small circles.

The software modules in FIG. 3 are interpreted as instantiations or instances of objects. A positioning axis instance 34 is depicted by the open circle. The hatched circle can depict a synchronization axis instance 36. Three positioning axis instances 34 and one synchronization instance 36 are to be executed on the device G.

A license manager implemented in software continuously checks the nominal—actual balance of required and existing licenses. A license manager can be integrated, for example, in the basic system 11 of the controller (see FIG. 1). In a modified embodiment, which is not illustrated in FIG. 1, the MMC card can have four PIN numbers, with a different PIN number assigned to each of the four software modules subject to licenses.

FIG. 4 shows a scenario for licensing and access authorization of software modules subject to licenses for several networked devices. The system illustrated in FIG. 4 includes three networked devices G1, G2 and G3, with the network connections indicated by continuous lines. An identification number 32 (PIN) containing the software licenses is assigned to each device G1, G2, G3 on an integratable MMC memory card MMC1, MMC2, MMC3, that can be inserted in the corresponding device G1, G2, G3. For example, MMC1 can contain two synchronization axis instance licenses 46, MMC2 two synchronization axis instance licenses 46 and one positioning axis instance license 44, and MMC3 a license for a synchronization axis instance with a cam disk 48, associated with the corresponding devices G1, G2 and G3. Accordingly, the entire system contains six licenses of three different types.

The software modules in FIG. 4 are interpreted as instantiations or instances of object types. The acquired licenses are encoded with an identification number 32 (PIN). The identification numbers 32 are transferred from the MMC memory cards MMC1, MMC2, MMC3, where there are stored, to the system or the devices G1, G2, G3. The existing licenses can be regarded as a credit. In the illustrated example, a total of six licenses are available in the three memory cards MMC1, MMC2, MMC3.

However, only five licenses are required based on the actual configuration, because the device G1 requires one positioning axis instance 44 and one synchronization axis instance 46, the device G2 two positioning axis instances 46, and the device G3 one synchronization axis instance with radial cam disk 48. The acquired licenses represent the consumption or the license debit. Since a sufficient number of licenses is available in the system, the configuration can be operated in this form and is fully licensed. The total number of licenses in the system decides the access authorization.

The license manager permanently records the number of licenses required by an application and compares that number with the number of licenses existing for the entire system. If a deficiency of licenses is detected, operation in the actual configuration is not permitted and/or enabled.

With respect to local devices, the number of the required licenses can exceed the number of the existing licenses. In the example depicted in FIG. 4, a synchronization axis instance 46 and a positioning axis instance 44 run on the device G1. However, two licenses for synchronization axis instances 46 are stored on the local MMC memory card MMC1 for the device G1. This local license deficit is compensated by the licenses assigned to the remaining devices. Accordingly, even when no licenses are assigned to individual devices, the software components assigned to the devices can still run properly and are properly licensed, if the sum total of the different licenses existing in the system is sufficient. Alternatively, all required licenses in the system can be introduced on a single device.

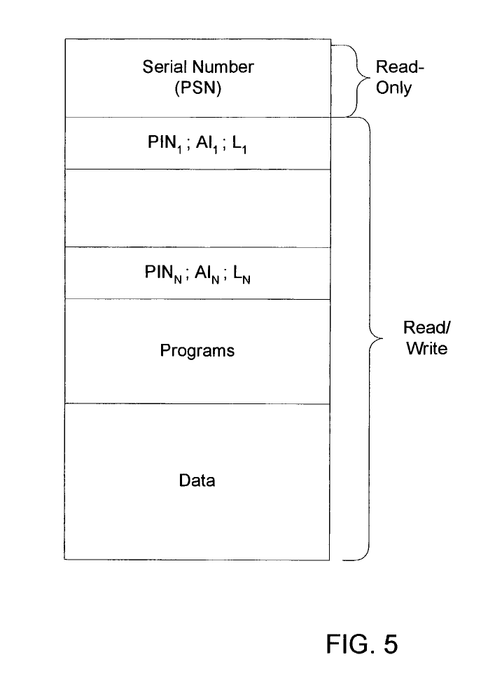

FIG. 5 shows schematically the internal organization of an MMC memory card. The MMC memory card is organized into blocks, with the uppermost block of the card representing a Card Identification Block which is written by the manufacturer of the MMC memory card. The Card Identification Block includes a unique hardware ID PSN (Part Serial Number). This region can only be read (by the checking software), but cannot be copied. The following blocks include the licenses Lᵢ, additional information Alᵢ (e.g., information of different licensors), as well as identification numbers PIN₁-PINₙ (of the different licensors). The MMC memory card can also contain other programs and data.

All blocks of an MMC memory card, except for the block containing the unique hardware ID PSN and which is only readable, are both readable and writeable and can also be copied.

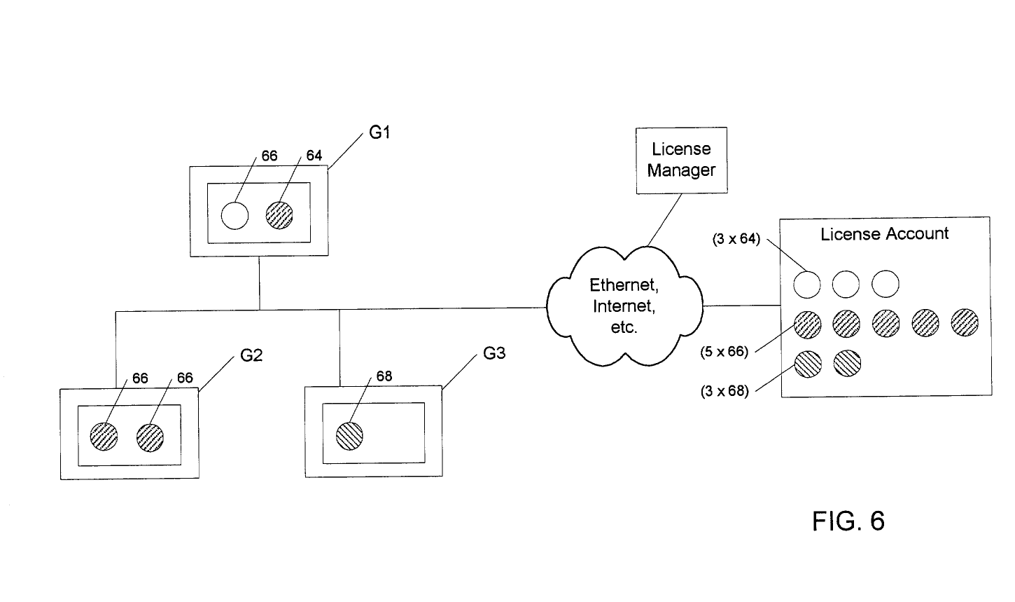

FIG. 6 illustrates a control system comprised of three networked, and G3, wherein the devices G1, G2, G3 can be connected, for example, via an Ethernet or the Internet to a server S which administers the license accounts. The licenses desired by the control system can be transmitted to the control system and the devices G1, G2, and G3 via the Ethernet and/or Internet connection.

The software modules (in FIG. 6 as exemplary instances of technology objects) to be executed on the devices G1, G2, and G3 are indicated by the small circles 64, 66, 68. The circle 64 indicates a positioning axis instance, the circles 66 a synchronization axis instance, and the circle 68 a synchronization axis instance with radial cam disk.

The server S transfers via the Ethernet or Internet connection licenses to the devices G1, G2, and G3 of the control system. The license account of the server S contains, for example, three positioning axis instance licenses 62 for the device G1, five synchronization axis instance licenses 64 for the device G2, and two licenses 68 for synchronization axis instances with radial cam disk for the device G3. Accordingly, there is a total of 10 licenses available to the control system.

However, based on the actual configuration, only five licenses are required, because of the device G1 requires one positioning axis instance 64 and one synchronization axis instance 66, the device G2 requires two synchronization axis instances 66, and the device G3 requires one synchronization axis instance with radial cam disk 68. The required licenses represent the consumption or the license debit. Since a sufficient number of licenses is available in the entire system, the operation in this configuration is permitted and properly licensed. Access authorization is decided based on the sum total of the licenses in the system.

With respect to local devices, the number of the required licenses can exceed the number of the existing licenses. In the example depicted in FIG. 6, two synchronization axis instances 66 run on the device G2. However, five licenses for synchronization axis instances 66 are stored on the server S license account. This local license deficit is compensated by the licenses assigned to the remaining devices or originating from other devices. Accordingly, although no licenses may be assigned to some individual devices, the software components assigned to the devices can still run properly under a license, if the sum total of the different licenses existing in the system is sufficient. Alternatively, all required licenses can be introduced into the system on a single device.

In the embodiment depicted in FIG. 6, a license manager 60 implemented in software checks continuously and/or in periodic intervals the nominal—actual balance of the required and existing licenses. The license manager 60 can be implemented in a distributed operation (distributed, for example, over a local area network or the Internet) as a mobile agent.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method for licensing and/or access authorization of software modules for an industrial control or computer system, comprising the steps of:
providing the software modules that are subject to a license with at least one piece of information about a license requirement applying to the software module;
authorizing use of a software module if a required license for the software module has been obtained;
providing a license manager for monitoring occasionally or periodically the number of licenses for the software modules subject to license in the industrial control or computer systems;
comparing the monitored number of licenses with the number of licenses required by the industrial control or computer systems for using the software modules subject to a license; and
authorized use of the software modules subject to a license, if the number of the used software modules subject to a license is equal to or smaller than the number of the licenses.

2. The method of claim 1, wherein the license manager is implemented in a distributed industrial control or computer system.

3. The method of claim 1, wherein the license manager is implemented as a mobile agent.

4. The method of claim 1, wherein the license manager automatically adapts the number of the licenses to the number of the used software modules.

5. The method of claim 1, wherein at least one license is transmitted via a data line or via the Internet to at least one industrial control or computer system.

6. The method of claim 1, wherein at least one license is transmitted via a data carrier, wherein the data carrier is also used to operate the industrial control or computer system.

7. The method of claim 1, wherein at least one license is stored on a memory card and supplied from the memory card to the industrial control or computer system.

8. The method of claim 1, wherein at least one license is stored on a multimedia card (MMC memory card, MMC1 - MMC3) and supplied to the industrial control or computer system.

9. The method of claim 1, wherein the industrial control or computer system includes a plurality of individual control devices, and wherein the licenses for the entire industrial control or computer system are supplied to at least one of the control devices.

10. The method of claim 1, wherein for establishing access authorization, the required licenses and the obtained licenses are compared at a time, when the software modules are installed in the industrial control or computer system.

11. The method of claim 1, wherein for establishing access authorization, the required licenses and the obtained licenses are compared at a time, when the software modules are used in the industrial control or computer system.
